(19) United States
(12) Patent Application Publication
(10) Pub. No.: US 2006/0193002 A1
(43) Pub. Date: Aug. 31, 2006

(54) Drive circuit chip and display device

(75) Inventors: Kouichi Satou, Kanagawa (JP); Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/362,032

(22) Filed: Feb. 27, 2006

(30) Foreign Application Priority Data
Feb. 28, 2005 (JP) 52569/2005
Aug. 30, 2005 (JP) 2005-249504

(51) Int. Cl. G06F 3/12

(52) U.S. Cl. 358/1.15

(57) ABSTRACT

A source driver according to an aspect of the present invention is a source driver for outputting image signals to an image-signal output terminal, and outputs image signals to an image-signal output terminal with a plurality of timings including a first timing and a second timing, which is different from the first timing, in response to a plurality of image-output control signals including a first and a second image-output control signals which are supplied from the outside during the same horizontal period.

### BACKGROUND OF THE INVENTION

1. Field of the Invention

The present invention relates to a drive circuit chip for a display device and a display device in which the drive circuit chip is used. Particularly, the present invention relates to control of timings of the drive circuit chip.

2. Description of Related Art

In these years, high development of the video/information-oriented society and increasingly wider use of multi-media systems have more and more increased the importance of flat displays such as liquid crystal display devices. Liquid crystal display devices have advantages including low power consumption, thinness and light weight. This has made liquid crystal devices widely used for display devices such as mobile terminal devices.

Passive matrix liquid crystal display devices and active matrix liquid crystal display devices have been heretofore known as liquid crystal display devices (see Japanese Patent Laid-open applications No. Hei. 01-200396, No. Hei. 07-104707 and No. Hei. 10-301536). As shown in FIG. 12, an active matrix liquid crystal display device 10 includes an active matrix liquid crystal display panel 11, a gate driver 12 for driving scan lines, source drivers 13 each for driving data lines, a controller 14 for supplying display data XDn and various timing signals (XCLK, XSTB and the like).

The liquid crystal display panel 11 includes a thin film transistor (TFT) array substrate, a counter substrate, and a liquid crystal interposed and held between the TFT array substrate and the counter substrate. On the TFT array substrate, a plurality of scan lines (gate lines GL), a plurality of data lines (source lines SL), pixel electrodes and TFTs are formed. The scan lines and the data lines are arrayed in a lattice. The pixel electrodes are arranged in a matrix. The TFTs are switching elements connected to the source lines SL and the pixel electrodes.

The output side of the gate driver 12 is connected to the gate lines GL of the liquid crystal display panel 11. The output sides of the source drivers 13 are connected to the source lines SL of the liquid crystal display panel 11. Display data are inputted to the controller 14 from an external host such as a PC, and the output side of the controller 14 is connected to the gate driver 12 and the source drivers 13.

Restrictions are imposed on the chip sizes of the gate driver 12 and the source drivers 13 due to constraints stemming from the production. This also limits the number of signals outputted from the gate driver 12 made up of a single chip to the gate lines GL and the number of signals outputted from the source driver 13 made up of a single chip to the source lines SL. For this reason, in a case where the liquid crystal panel 11 is larger, a plurality of the gate drivers (chips) 12 and a plurality of the source drivers (chips) 13 need to be arranged. FIG. 12 shows a case where two source drivers 13 (a source driver A 13a and a source driver B 13b) are provided thereto.

In a case where display is performed by the liquid crystal display device 10, various timing signals such as vertical synchronizing signals Vsync and horizontal synchronizing signals Hsync are inputted to the controller 14. Clock signals and selection pulse signals for sequentially selecting the gate lines GL are inputted from the controller 14 to the gate driver 12. In addition, the various timing signals and display data for indicating a gray scale corresponding to each of the source lines SL are transmitted from the controller 14 to each of the source drivers 13. Each of the source drivers 13 generates gray scale voltages by means of applying D/A conversion to display data which has been obtained, and outputs the gray scale voltages, as image signals, to the corresponding source lines.

Scan signals in the form of pulses are supplied from the gate driver 12 to the respective gate lines GL. When a scan signal supplied to a gate line GL is at an “ON” level, all of the TFTs connected to the gate line GL are turned on. An image signal supplied to a source line SL from one of the source driver 13 is supplied to pixel electrodes through the TFTs which have been turned on. Subsequently, when the TFTs are turned off after the scan line is turned to an “off” level, pixel voltages respectively obtained by adding offset voltages to the supplied image signal due to field-through of the TFTs are held in liquid crystal capacities or auxiliary capacities until a scan signal is supplied to the gate line GL for the next frame. Then, scan signals are sequentially supplied to the respective gate lines GL. Thereby, predetermined image signals are supplied to all of the pixel electrodes. By means of rewriting image signals for each frame cycle, an image can be displayed.

However, the source drivers 13 for supplying image signals to the liquid crystal display panel 11 have the following problem. Descriptions will be provided for the problem with the conventional source drivers 13 with reference to FIG. 13. In each of the source drivers 13, the input of the display data holding unit 15 is connected to the controller 14, and the output side of the data holding unit 15 is connected to a latch circuit 16. The output side of the latch circuit 16 is connected to a D/A converter 17, and the output side of the D/A converter 17 is connected to buffers 18. In addition, an image-output control signal (XSTB) is inputted from the controller 14 to the latch circuit 16 and the buffers 18.

In the case of the source drivers 13 each having the aforementioned configuration, first of all, in the source driver A 13a shown in FIG. 12, display data to be inputted to the pixel electrodes connected to one gate line GL in an area A (one half) of the liquid crystal display panel 11 are sequentially inputted to the display data holding unit 15. The display data holding unit 15 expands, and holds, the display data which have been sequentially inputted thereto. The held display data which are going to be inputted to the gate line GL in the area A are latched by the latch circuit 16 at a timing representing the rise of the image-output control signal (XSTB), and are outputted to the D/A converter 17 parallel all at once. Subsequently, the display signals are outputted from the buffers 18 to the source lines SL at a timing representing the fall of the image-output control signal (XSTB). At this time, all of the output signals for the single gate line in the area A are simultaneously outputted from the source driver 13 made of a single chip, as shown in FIG. 14. This makes large a peak current which occurs instantaneously in the source driver 13 made of the single chip. Accordingly, this brings about a problem that a large electromagnetic interference (EMI) noise occurs in the source driver 13.

### SUMMARY OF THE INVENTION

An aspect of the present invention is a drive circuit chip for outputting image signals to image-signal output terminals. The drive circuit chip outputs the image signals to the image-signal output terminals with a plurality of timings including a first timing and a second timing, which is different from the first timing, in response to a plurality of image-output control signals including a first and a second image-output control signals which are supplied from the outside during the same horizontal period. If a drive circuit chip has such a configuration, this makes it possible to reduce the number of signals simultaneously outputted from the drive circuit chip. Accordingly, in the drive circuit made of the single chip, a peak current can be reduced, and thereby EMI noise can be reduced.

### BRIEF DESCRIPTION OF THE DRAWINGS

FIG. 1 is a schematic diagram showing an example of a configuration of a display device according to a first embodiment.

FIG. 2 is a schematic diagram showing an example of a configuration of a drive circuit according to the first embodiment.

FIG. 3 is a schematic diagram showing an example of an output buffer unit of the drive circuit according to the first embodiment.

FIG. 4 is a chart of timings which are given when the drive circuit according to the first embodiment is used.

FIG. 5 is a waveform diagram for describing an operation performed by the drive circuit according to the first embodiment.

FIG. 6 is a schematic diagram showing an example of a configuration of a drive circuit according to a second embodiment.

FIG. 7 is a schematic diagram showing an example of a sample hold circuit of the drive circuit according to the second embodiment.

FIG. 8 is a timing chart for describing an operation performed by a drive circuit according to a third embodiment.

FIG. 9 is a schematic diagram showing an example of a configuration of a drive circuit according to a fourth embodiment.

FIG. 10 is a schematic diagram showing an example of an output buffer unit of the drive circuit according to the fourth embodiment.

FIG. 11 is a chart of timings which are given when the drive circuit according to the fourth embodiment is used.

FIG. 12 is a diagram showing a configuration of a conventional liquid crystal display device.

FIG. 13 is a diagram showing a configuration of a conventional drive circuit.

FIG. 14 is a diagram for describing an operation performed by the conventional drive circuit.

FIG. 15 is a chart of timings which are given when the conventional drive circuit is used.

### DESCRIPTION OF THE PREFERRED EMBODIMENTS

### First Embodiment

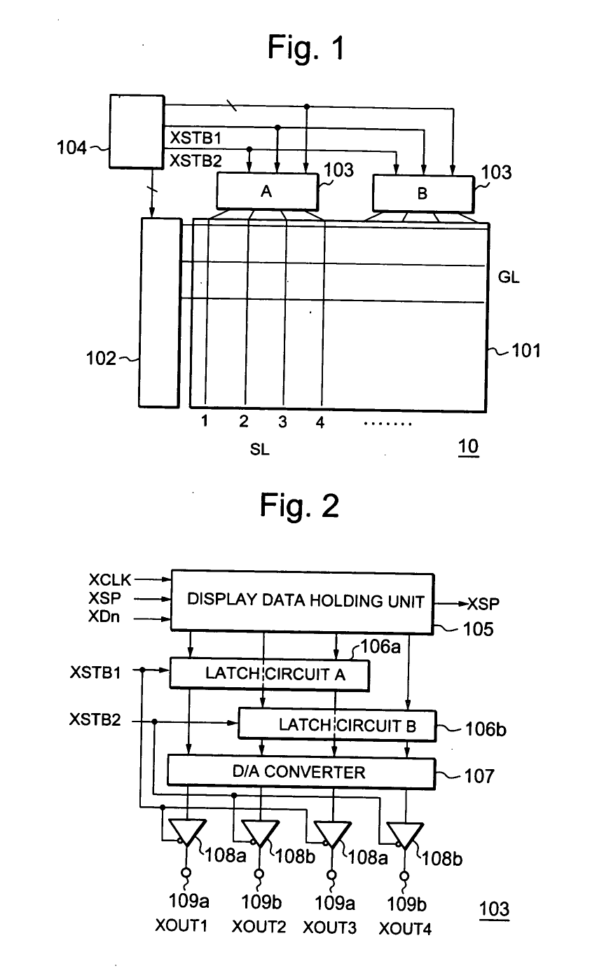

Descriptions will be provided for a display device according to a first embodiment of the present invention with reference to FIG. 1. Here, an active matrix liquid crystal display device of transmissive type will be described as an example of the display device. FIG. 1 is a schematic diagram of a liquid crystal display device 100 according to this embodiment. The liquid crystal display device 100 includes a liquid crystal display panel 101 for displaying images; a scan line driver (hereinafter referred to as a “gate driver”) 102 for driving scan lines (hereinafter referred to as “gate lines GL”); data line drivers 103 each for driving data lines (hereinafter referred to as “source lines SL”). This figure shows an example where two source drivers 103 are arranged. A source driver A 103a and a source driver B 103b are shown in FIG. 1. Each of the source drivers 103 is fabricated as a semiconductor chip. In addition, the liquid crystal display device 100 includes a controller 104 for supplying display data in the form of digital signals, and for supplying various timing signals; a power supply (not illustrated); and the like.

The liquid crystal display panel 101 includes a display region made up of a plurality of pixels. The liquid crystal display panel 101 has a configuration in which liquid crystal is interposed, and supported, between a thin film transistor (TFT) array substrate (not illustrated) and an counter substrate (not illustrated) which is arranged opposite to the TFT array substrate. On the TFT array substrate, the gate lines GL are formed in the horizontal direction in FIG. 1, and the source lines SL are formed in the vertical direction in FIG. 1. An active element such as a TFT is provided to the vicinity of each of the intersections between the gate lines GL and the source lines SL. A plurality of pixel electrodes are formed between the gate lines and the source lines so that the plurality of pixel electrodes are arranged in a matrix. A gate of each of the TFTs is connected to one of the gate lines GL, one electrode of each source/drain is connected to one of the source lines SL, and the other electrode of each source/drain is connected to one of the pixel electrodes.

Meanwhile, on the counter substrate, a common electrode, color filters R (red), color filters G (green) and color filters (blue) are formed. The common electrode is a transparent electrode formed on the virtually entire surface of the counter substrate in a way that the common electrode is actually opposite to the pixel electrodes. Scan signals in the form of pulses are supplied to the respective gate lines GL from the gate driver 102. When a scan signal supplied to a gate line GL is at an “on” level, all of the TFTs connected to the gate line GL are turned on. Image signals supplied to the source lines SL from the source drivers 103 are supplied to pixel electrodes through the TFTs which have been turned on. If the TFTs are subsequently turned off in response to the scan signal being turned to an “off” level, pixel voltages obtained by adding an offset voltage to the supplied image signals by means of a field through of the TFTs are held by liquid crystal capacities and auxiliary capacities until a scan signal is supplied to the gate lines GL in the next frame. Then, by means of supplying scan signals sequentially to the gate lines GL, predetermined image signals are supplied respectively to all of the pixel electrodes. A rewrite of image signals with a frame period makes it possible to display images.

Orientation of the liquid crystal between each of the pixel electrodes and the common electrode is changed in response to difference between a pixel voltage of each of the pixel electrodes and a voltage of the common electrode. This change controls an amount of transmission of light which is made incident from a backlight (not illustrated). Each of the pixels of the liquid crystal display panel 101 displays various hues by means of saturation of colors in response to the amount of light being transmitted and a display of R, G and B colors. Incidentally, in the case of a monochrome display, the color filters are not provided.

The arresting feature of the present invention lies in the source drivers 103. Detailed descriptions will be provided below for the source drivers 103 with reference to FIG. 2. Incidentally, the source driver A 103a and the source driver B 103b are provided with the same circuit configuration. First, each of the source drivers 103 according to the present embodiment are different from each of the conventional source drivers 13 shown in FIG. 13 in that display data are outputted from a data latch circuit 106 to a D/A converter 107 with a plurality of timings. Second, each of the source drivers 103 according to the present embodiment are different from each of the conventional source drivers 13 shown in FIG. 13 in that image signals are outputted from output buffer units 108 respectively to image signal output terminals 109 with a plurality of timings, and in that the output timings are different from one another. Here, descriptions will be provided for a case where two data latch circuits 106 whose control signals are different from each other are provided to the inside of each of the source drivers 103 so that the two data latch circuits 106 output display data with the respective timings which are different from each other, and where two output buffer units 108 whose control signals are different from each other are provided to the inside of each of the source drivers 103. Incidentally, for the purpose of making the descriptions simple, the source drivers 103, each of which drives pixels in 4 columns×1 row in the horizontal direction, will be described.

As shown in FIG. 2, each of the source drivers 103 according to this embodiment includes a display data holding unit 105, a first latch circuit A 106a, a second latch circuit B 106b, a D/A converter 107, output buffer units 108 and image-signal output terminals 109. With regard to the output buffer units 108, first output buffer units 108a to which output from the first latch circuit A 106a is inputted (through the D/A converter 107) and second output buffer units 108b to which output from the second latch circuit B 106b is inputted (through the D/A converter 107) are provided to each of the source drivers 103. In the case of the example shown in FIG. 2, the first output buffer units 108a process signals corresponding to odd-numbered source lines SL (image-signal output terminals 109a) in the liquid crystal display panel 101, and the second output buffer units 108b process signals corresponding to even-numbered source lines SL (image signal output terminals 109b) in the liquid crystal display panel 101.

The input of the display data holding unit 105 is connected to the controller 104, and the output side of the display data holding unit 105 is connected to the first latch circuit A 106a and the second latch circuit B 106b. The output sides respectively of the latch circuits 106 are connected to the D/A converter 107. The output side of the D/A converter 107 is connected to the output buffer units 108. The source drivers 103 are connected with the source lines SL of the liquid crystal display panel 101 through a plurality of image-signal output terminals 109. Image signals outputted from the output buffer units 108 are supplied to the source lines SL of the liquid crystal display panel 101 through the image-signal output terminals 109.

The display data holding unit 105 expands, and holds, display data inputted sequentially from the controller 104, and outputs the held display data parallel. The first latch circuit A 106a and the second latch circuit B 106b latch the display data outputted parallel from the display data holding unit 105 with their respective latch timings, and output the latched display data to the D/A converter 107. The D/A converter 107 converts the display data, which have been outputted from the first latch circuit 106a and the second latch circuit 106b, to gray scale voltages depending on the display data. The first output buffer unit 108a and the second output buffer unit 108b output the gray scale voltages, which have been inputted to the first and second output buffer units, as image signals, to the source lines SL of the liquid crystal display panel 101 with their respective output timings.

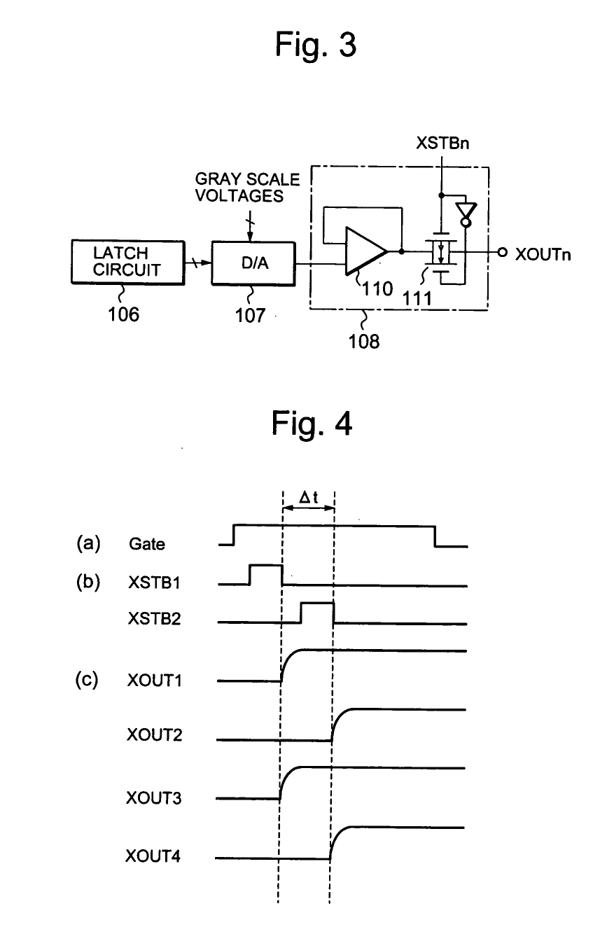

FIG. 3 shows an example of a configuration of one of the output buffer units 108. Each of the output buffer units 108 includes an output buffer 110 and a switch 111. The input of the output buffer 110 is connected to the D/A converter 107, and the output side of the output buffer 110 is connected to the switch 111. The output buffer 110 converts the gray scale voltage, which has been inputted from the D/A converter 107, to an image signal by means of applying impedance conversion to the gray scale voltage, and outputs the image signal. The switch 111 is turned on in response to an image-output control signal inputted from the controller 104, and thus the image signal supplied from the output buffer 110 is outputted to the corresponding one of the image signal output terminals 109a.

Here, detailed descriptions will be provided for an operation which is performed in a case where the liquid crystal display panel 101 is driven by use of one of the source drivers 103 each having the aforementioned configuration. First of all, display data (video data) from an external host such as a PC as well as various timing signals such as a vertical synchronizing signal Vsync and a horizontal synchronizing signal Hsync are inputted to the controller 104. A clock signal and a selection pulse signal for selecting gate lines GL sequentially are inputted from the controller 104 to the gate driver 102. In accordance with the clock signal, the gate driver 102 outputs a scan signal to each of the gate lines GL while sequentially transferring the inputted selection pulse signal.

On the other hand, output control signals including a first image-output control signal and a second image-output control signal as well as display data for indicating gray scales are inputted from the controller 104 to each of the source drivers 103. While gate lines are selected by means of the scan signals, each of the source drivers 103 supplies the image signal to each of pixels connected to the selected gate lines.

A selection pulse signal XSP and a clock signal XCLK are inputted from the controller 104 to the display data holding unit 105. The display data holding unit 105 includes a shift register and an input data latch block in which a plurality of latches are connected to one another vertically. The selection pulse signal XSP is inputted to the shift register, and is sequentially transferred one stage backward in synchronism with the clock signal XCLK.

Display data corresponding to the respective source lines SL are latched by input data latches selected by outputs from flip-flops of the shift register. By this, the display data holding unit 105 expands, and holds, the display data inputted sequentially from the controller 104.

An image-output control signal 1 (XSTB1) which is the first image-output control signal is inputted from the controller 104 to the first latch circuit A 106a. The first latch circuit A 106a latches the display data outputted parallel from the display data holding unit 105 at a rise edge of the image-output control signal 1 (XSTB1), which rise edge represents a third timing. In addition, the first latch circuit A 106a outputs the display data thus latched (signals corresponding to two odd-numbered source lines SL in this example) parallel to the D/A converter 107. In accordance with the display data thus inputted, the D/A converter 107 applies D/A conversion to a plurality of gray scale voltages generated by a gray-scale-voltage generating circuit (not illustrated); and outputs desired gray scale voltages to the output buffer units 108.

The image-output control signal 1 (XSTB1) is also inputted to the switch 111 of the first output buffer unit 108a. The switch 111 of the first output buffer unit 108a is turned off at the rise edge of the image-output control signal 1 (XSTB1), which rise edge represents the third timing, and thus output from the first output buffer unit 108a takes on a high impedance. While the output of the first output buffer unit 108a is taking on the high impedance, the D/A converter 107 applies D/A conversion to the digital output from the first latch circuit A 106a. Subsequently, the output buffer 110 provided to the first output buffer unit 108a converts the gray scale voltage, which has been inputted from the D/A converter 107, to an image signal by means of applying impedance conversion to the gray scale voltage, and outputs the image signal. Thereafter, the switch 111 is turned on at the fall edge of the image-output control signal 1 (XSTB1), which fall edge represents a first timing, and thus the image signal obtained by the conversion is outputted to the image signal output terminal 109a.

The second latch circuit B 106b starts to latch, and to output, the display data, following the first latch circuit A 106a. An image-output control signal 2 (XSTB2) which is a second image-output control signal is inputted to the second latch circuit B 106b from the controller 104. The second latch circuit B 106b latches the display data outputted parallel from the display data holding unit 105 at the rise edge of the image-output control signal 2 (XSTB2), which rise edge represents a fourth timing. In addition, the second latch circuit B 106b outputs the display data thus latched (signals corresponding to two even-numbered source lines SL in this example) parallel to the D/A converter 107. In accordance with the display data thus inputted, the D/A converter 107 applies D/A conversion to a plurality of gray scale voltages generated by the gray-scale-voltage generating circuit (not illustrated), and outputs desired gray scale voltages to the output buffer units 108.

The image-output control signal 2 (XSTB2) is also inputted to the switch 111 of the second output buffer unit 108b. The switch 111 of the second output buffer unit 108b is turned off at the rise edge of the image-output control signal 2 (XSTB2), which rise edge represents the fourth timing, and thus output from the second output buffer unit 108b takes on a high impedance. While the output of the second output buffer unit 108b is taking on the high impedance, the D/A converter 107 applies D/A conversion to the digital output from the second latch circuit B 106b. Subsequently, the output buffer 110 provided to the second output buffer unit 108b converts the gray scale voltage, which has been inputted from the D/A converter 107, to an image signal by means of applying impedance conversion to the gray scale voltage, and outputs the image signal. Thereafter, the switch 111 is turned on at the fall edge of the image-output control signal 2 (XSTB2), which fall edge represents the second timing, and thus the image signal obtained by the conversion is outputted to the image signal output terminal 109b.

In other words, the display data expanded and held in the display data holding unit 105 are latched by the latch circuit A 106a and the latch B 106b respectively with the third timing and the fourth timing which are different from each other. Subsequently, the image signals are outputted to the odd-numbered source lines SL and the even-numbered source lines SL of the liquid crystal display panel 101 at any one of the first timing and the second timing which are different from each other. In sum, the number of the image signals outputted simultaneously from each of the source drivers according to the present embodiment is reduced to one half of the number of image signals outputted simultaneously from a source driver according to the conventional technologies. FIG. 4 shows a chart of timings which are given when each of the source drivers 103 according to the present embodiment is used. Part (a) of FIG. 4 denotes a scan signal Gate to be supplied to the gate lines GL. Part (b) of FIG. 4 denotes image-output control signals to be inputted to the latch circuits 106 and the output buffer units 108 of the source driver 103. Part (c) of FIG. 4 denotes image signals to be supplied to the pixel electrodes connected to the source lines SL of the liquid crystal display panel 101.

As shown in Part (a) of FIG. 4, a scan signal in the form of a pulse is transmitted from the gate driver 102 to each of the gate lines GL. When a scan signal supplied to one of the gate lines GL is at an “on” level, all of the TFTs connected to the gate line GL are turned on. While the TFTs are being turned on, an image signal transmitted from the source drivers 103 to the source lines SL is supplied to pixel electrodes through the TFTs which have been turned on. Thereafter, when the scan signal is turned to an “off” level and consequently the TFTs are turned off, the potential difference between each of the pixel electrodes and the counter substrate electrode is held by the liquid crystal capacity, the auxiliary capacity and the like until the next image signal is supplied to the pixel electrodes. By means of transmitting scan signals sequentially to the gate lines GL, predetermined image signals are supplied to all of the pixel electrodes. A rewrite of image signals with a frame period makes it possible to display images.

As shown in Part (b) of FIG. 4, the timing (the first timing) of the fall edge of the image-output control signal 1 (XSTB1) is different from the timing (the second timing) of the fall edge of the image-output control signal 2 (XSTB2), which has been described above. After the image-output control signal 1 (XSTB1) is inputted, the image-output control signal 2 (XSTB2) is inputted at a timing deferred by a time Δt from the timing of the image-output control signal 1 (XSTB1). For this reason, the source drivers 103 output an image signal to the odd-numbered source lines of the liquid crystal display panel 101, and thereafter outputs the image signal to the even-numbered source lines of the liquid crystal display panel 101, in the case of this embodiment.

As described above, the image signal is outputted to each of the source lines SL at the fall edge (the first timing) of the image-output control signal 1 (XSTB1) or at the fall edge (the second timing) of the image-output control signal 2 (XSTB2). Accordingly, as shown in Part (c) of FIG. 4, the pixel electrodes connected to the odd-numbered (1, 3, . . . , 2m−1: m is a natural number) source lines SL are supplied with the image signals in response to the fall edge (the first timing) of the image-output control signal 1 (XSTB1) shown in Part (b) of FIG. 4. Thus, the electric charges are accumulated in the pixel electrodes while the scan signal Gate is at the “on” level. Thereafter, the pixel electrodes connected to the even-numbered (2, 4, . . . , 2m: m is a natural number) source lines SL are supplied with the image signal in response to the fall edge (the second timing) of the image-output control signal 2 (XSTB2) shown in Part (b) of FIG. 4. Thus, the electric charges are accumulated in the pixel electrodes while the scan signal Gate is at the “on” level.

Furthermore, as shown in FIG. 4, the sequence of the timings are not limited to the sequence from the third timing, the first timing, the fourth timing to the second timing while in the same horizontal period. For example, it does not matter that the first timing comes after the fourth timing, and before the second timing. In other words, a sequence from the third timing, the fourth timing, the first timing to the second timing does not matter. In addition, none of the following sequences matter: a sequence from the third timing, the fourth timing, the second timing to the first timing; a sequence from the fourth timing, the second timing, the third timing to the first timing; a sequence from the fourth timing, the third timing, the second timing to the first timing; a sequence from the fourth timing, the third timing, the first timing to the second timing; a sequence from the third timing=the fourth timing, and the first timing to the second timing; and a sequence from the third timing=the fourth timing, and the second timing to the first timing.

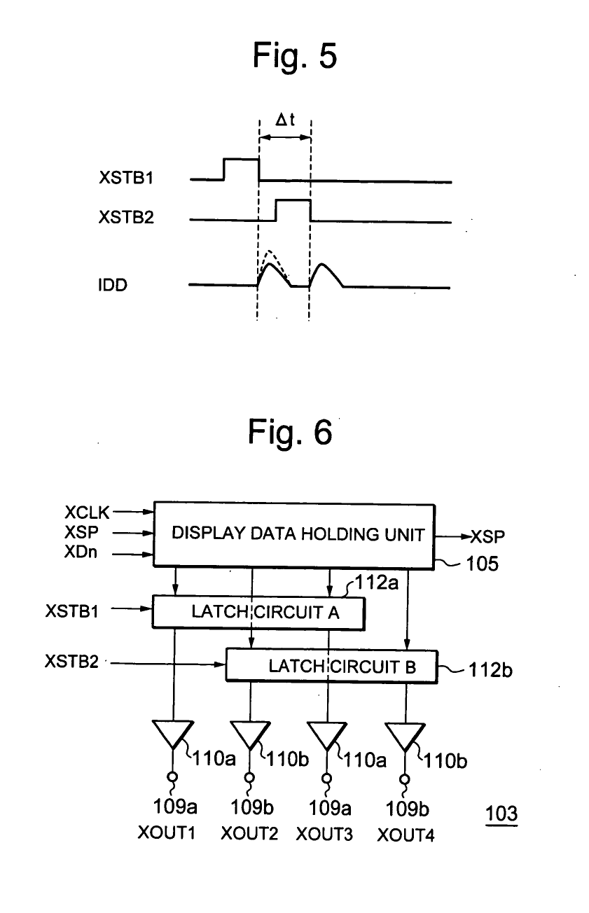

FIG. 5 shows a power current IDD which is consumed in each of the source drivers 103 in a case where the source drivers 103 are driven in the aforementioned manner. A broken line shows a peak current which occurs in a case where display data having been accumulated in one gate line GL are loaded to one of the latch circuits all at once in response to an image-output control signal, and the loaded display data are outputted to the D/C converter parallel and all at once. As learned from FIG. 5, the timings of the fall edges of the two image-output control signals are different from each other by the time Δt in the ease of each of the source drivers according to this embodiment. This makes it possible to inhibit a peak current which would otherwise occur instantaneously in each of the source driver chips. Consequently, this makes it possible to inhibit electromagnetic interference (EMI) noise which would otherwise occur stemming from the peak current.

It should be noted that, in the case of this embodiment, the input terminal for an image-output control signal of the source driver A 103a is connected with the input terminal for the same image-output control signal of the source driver B 103b through wiring. For this reason, any one of the source image-output control signals is inputted to the source driver A 103a and the source driver B 103b with the same timing. Specifically, an image signal is supplied to all of the odd-numbered source lines SL with the first timing, and the image signal is supplied to all of the even-numbered source lines SL with the second timing, in the liquid crystal display panel 101.

However, it does not matter that an image-output control signal to be inputted to the source driver A 103a and an image-output control signal to be inputted to the source driver B 103b are different from each other in timing. In other words, the two electric wires through which the respective image-output control signals are transmitted from the controller 104 to the source driver A 103a and the two electric wires through which the respective image-output control signals are transmitted from the controller 104 to the source driver B 103b may be formed separately from each other. In other words, it does not matter that the image signal is outputted from the source driver A 103a to the corresponding image-signal output terminals 109 with the first and second timings whereas the image signal is outputted from the source driver B 103b to the corresponding image-signal output terminals 109 with the fifth and sixth timings which are different from the first and second timings.

As understood from the above description, after display data for one source line are expanded and held in the display data holding unit 105 in all of the source drivers 103, the image signals start to be outputted in accordance with the image-output control signals. For this reason, the difference Δt in timing between the image-output control signals can be set up arbitrarily. This embodiment is not limited to the timings for outputting the signals being determined in response to the timing for inputting the display data to each of the source drivers, although such determination has been made in the case of the conventional technologies. It may be desirable that Δt be smaller, for example, from a viewpoint of image quality. By contrast, Δt needs to be set at a considerably large value from a viewpoint of inhibition of the EMI noise in each of the source drivers.

Δt can be easily changed by means of changing the timings of the image-output control signals inputted from the controller 104. Δt can be regulated by means of providing a counter to the inside of the controller 104. If the counter is provided to the inside of the controller 104, this makes it possible to regulate the timings of the image-output control signals, for example, in response to the wiring distance in each of the source drivers 103 over which the EMI noise is propagated. Accordingly, this makes it possible to reduce the EMI noise more effectively while maintaining the image quality.

This embodiment has been described giving the example where the two image-output control signals are provided by means of setting n of “the nth (n: a natural number) image-output control signal supplied from the controller 104” at 1 and 2. However, it should be noted that this embodiment is not limited to this. Three or more image-output control signals may be provided, for example, by means of setting n at three or a larger number. If three or more image-output control signals are provided, this makes it possible to decrease the number of signals simultaneously outputted from the source drivers 103. Furthermore, this makes it possible to reduce the peak current, and to reduce the EMI noise resultantly. For example, the following design may be made: three different timings are set up in a way that the three timings correspond respectively to the colors R, G and B, and image signals are outputted from the respective image-signal output terminals, which are adjacent to one another, at the three different timings. It is desirable that image signals representing any one of the three colors be outputted at the same timing.

### Second Embodiment

The first embodiment has been described giving the example where display data are in the form of digital signals. However, display data may be in the form of analogue signals. In other words, display data in the form of analogue signals may be expanded and held in a sample hold circuit configured of a plurality of switches and a plurality of condensers.

FIG. 6 is a circuit diagram showing a source driver 103 according to the second embodiment. As shown in FIG. 6, the source driver 103 according to the second embodiment includes a display data holding unit 105, a first sample hold circuit A 112a, a second sample hold circuit B 112b, a D/A converter 107 and output buffers 111. What makes this embodiment different from the first embodiment is that the first latch circuit A 106a shown in FIG. 2 is replaced with the first sample hold circuit A 112a, and the second latch circuit B 106b shown in FIG. 2 is replaced with the second sample hold circuit B 112b.

The input of the display data holding unit 105 is connected to the controller 104, and the output side of the display data holding unit 105 is connected to the first sample hold circuit A 112a and the second sample hold circuit B 112b. The output sides respectively of the sample hold circuits 112 are connected to the output buffers 110. The source drivers 103 are connected with the source lines SL of the liquid crystal display panel 101 respectively through a plurality of image signal output terminals 109. Image signals outputted from the output buffers 110 are supplied to the respective source lines SL of the liquid crystal display panel 101 through the corresponding image signal output terminals 109.

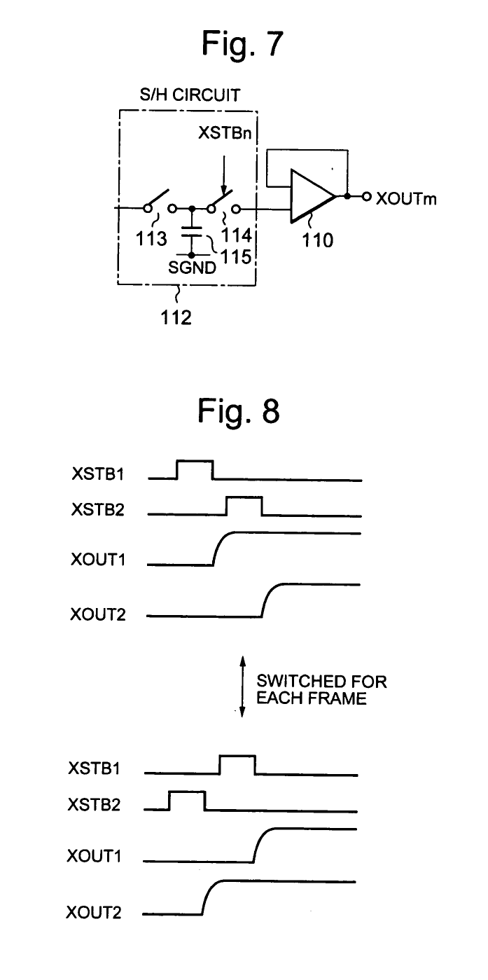

FIG. 7 shows an example of one of the sample hold circuits 112. The sample hold circuit 112 shown in FIG. 7 has a one-sample-hold/one-amplifier configuration, and includes a sampling switch 113, an output switch 114 and a sampling condenser 115. Analogue display data are supplied to the sampling switch 113. The sample hold circuit 112 may include a two-sample-hold/one-amplifier configuration constituting two sample hold circuits.

Here, descriptions will be provided for an operation which is performed in a case where the liquid crystal display panel 101 is driven by use of the source drivers 103 each having the aforementioned configuration. A sampling signal XSP and a clock signal XCLK are inputted from the controller 104 to the display data holding unit 105. The display data holding unit 105 includes a shift register (not illustrated). The sampling signal XSP is inputted to the shift register, and is sequentially transferred one stage backward in synchronism with the clock signal XCLK.

The sampling switches 113 respectively in the sample hold circuit A 112a and the sample hold circuit B 112b are controlled in response to the sampling signal XSP. When the sampling switches 113 are turned on, the sampling condensers 115 hold the analogue display data outputted from the display data holding unit 105. By this, the sample hold circuit A 112a and the sample hold circuit B 112b expand, and hold, the display data inputted sequentially from the controller 104.

An image-output control signal 1 (XSTB1) which is a first image-output control signal is inputted from the controller 104 to the sample hold circuit A 112a. The output switch 114 of the sample hold circuit A 112a is controlled by the image-output control signal 1 (XSTB1). In addition, an image-output control signal 2 (XSTB2) which is a second image-output control signal is inputted from the controller 104 to the sample hold circuit B 112b. The output switch 114 of the sample hold circuit B 112b is controlled by the image-output control signal 2 (XSTB2).

The sample hold circuit A 112a turns on the output switch 114 at the fall edge of the image-output control signal 1 (XSTB1), which fall edge represents a first timing, and thus outputs the analogue display data, which have been held in the sampling condenser 115, to the output buffer 110. Thereafter, the output buffer 110 converts the inputted display data to an image signal by means of applying impedance conversion to the inputted display data, and output the image signal to the image-signal output terminal 109a.

The sample hold circuit B 112b starts to sample, and to output, the display data at a timing deferred by a time Δt from the timing of the sample hold circuit A 112a. As described above, the image-output control signal 2 (XSTB2) which is a second image-output control signal is inputted from the controller 104 to the second latch circuit B 106b. The sample hold circuit B 112b turns on the output switch 114 at the fall edge of the image-output control signal 2 (XSTB2), which fall edge represents a second timing, and thus outputs the analogue display data, which have been held in the sampling condenser 115, to the output buffer 110. Thereafter, the output buffer 110 converts the inputted display data to an image signal by applying impedance conversion to the inputted display data, and output the image signal to the image-signal output terminal 109b.

Specifically, as in the case of the first embodiment, by means of making the timing of the image-output control signal 1 (XSTB1) and the timing of the image-output control signal 2 (XSTB2) different from each other by Δt, the image signals can be respectively outputted from the output buffers 110 at the different timings. In other words, the image signals are outputted to the odd-numbered source lines SL and the even-numbered source lines SL of the liquid crystal display panel 101 respectively at the first timing and the second timing which are different from each other. In sum, the number of image signals outputted simultaneously from one source driver according to this embodiment is reduced to one half of the number of image signals outputted simultaneously from one source driver according to the conventional technologies. This makes it possible to inhibit a peak current which would otherwise occur instantaneously in each of the source driver chips. Consequently, this makes it possible to inhibit electromagnetic interference (EMI) noise which would otherwise stem from the peak current.

### Third Embodiment

In the cases of the first embodiment and the second embodiment, the timing of the image-output control signal 1 (XSTB1) and the timing of the image-output control signal 2 (XSTB2) are different from each other by Δt. Time spent to write the image signal into the pixel electrodes connected to the odd-numbered source lines is longer by Δt than into the pixel electrodes connected to the even-numbered source lines. If it could take a sufficient time to write the image signal into the pixel electrodes, there would be no influence on the image quality. If the display panel is made larger and more precise, not only the load capacity becomes larger, but also one horizontal period becomes shorter.

For this reason, with regard to the odd-numbered source lines and the even-numbered source lines in the liquid crystal display panel 101, columns of pixel electrodes into which the image signal is insufficiently written alternate with columns of pixel electrodes into which the image signal is sufficiently written.

Moreover, in the case of the conventional liquid crystal display device, as shown in FIG. 15, image signals are supplied from the source driver A 13a to the liquid crystal display panel 11, and thereafter image signals corresponding to display data are outputted from the source driver B 13b. In other words, the source driver B 13b simultaneously outputs all of the output signals for one gate line in the region B at a timing deferred from the timing at which the image signals have been outputted from the source driver A 13a.

In the case of such a driving method, a time length needed for supplying desired image signals is different between a region A driven by the source driver A 13a and the region B driven by the source driver B 13b, as shown in FIG. 15. For this reason, inter-block display unevenness occurs between the region A, which is supplied with the image signals earlier, and the region B, which is supplied with the image signals later.

With this taken into consideration, in the case of this embodiment, the timing of the image-output control signal 1 (XSTB1) and the timing of the image-output control signal 2 (XSTB2) are reversed back and forth for each frame, as shown in FIG. 8. In other words, the first and second timings with which the image signals are supplied to a group of the odd-numbered source lines SL and a group of the even-numbered source lines SL are reversed back and forth for each frame. This makes it possible to reduce the display unevenness of a vertical line between the blocks as described above, and to accordingly enhance the display quality.

### Fourth Embodiment

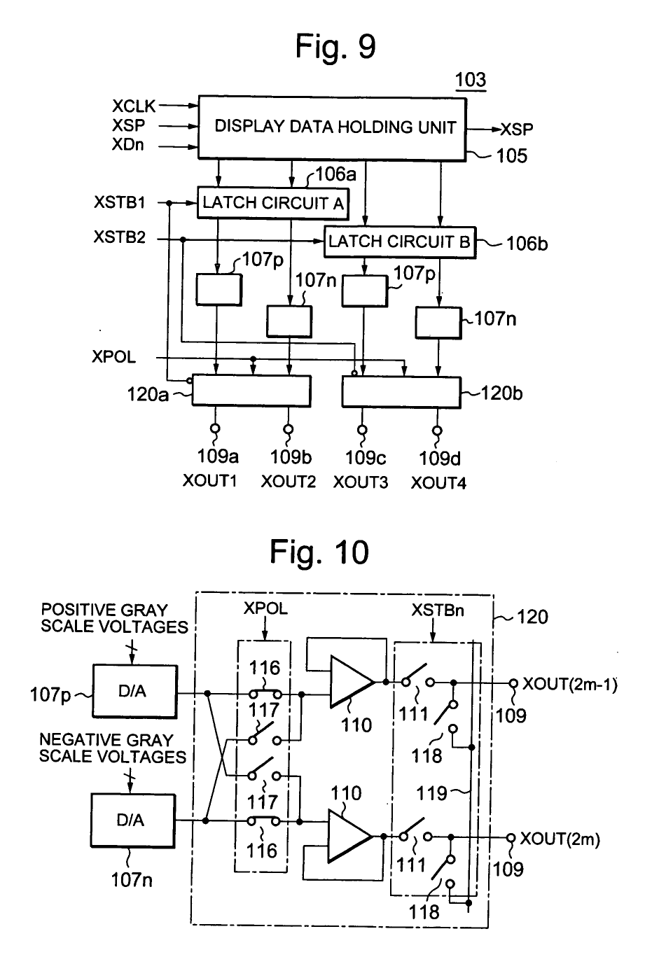

Descriptions will be provided for a fourth embodiment of the present invention with reference to FIG. 9. FIG. 9 is a diagram showing an example of a configuration of a source driver 103 according to the fourth embodiment. As shown in FIG. 9, the source driver 103 according to this embodiment includes a display data holding unit 105, a latch circuit A 106a, a latch circuit B 106b, positive D/A converters 107p, negative D/A converters 107n and output buffer units 120. The source driver 103 according to this embodiment drives the liquid crystal display panel 101 by means of the dot inversion driving system. In FIG. 9, the same components as those in FIG. 1 are denoted by the same reference numerals and symbols as those in FIG. 1 are denoted, and thus descriptions for the same components as those in FIG. 1 are omitted.

Descriptions will be provided for what makes the source driver 103 according to this embodiment different from the source driver 103 according to the first embodiment. In the case of the dot iversion driving system, when positive image signals are outputted respectively from the image-signal output terminals 109a and 109c (XOUT1 and XOUT3) in the odd-numbered lines, negative image signals are outputted respectively from the image-signal output terminals 109b and 109d (XOUT2 and XOUT4) in the even-numbered lines. In addition, when negative image signals are outputted respectively from the image-signal output terminals 109a and 109c (XOUT1 and XOUT3) in the odd-numbered lines, positive image signals are outputted respectively from the image-signal output terminals 109b and 109d (XOUT2 and XOUT4) in the even-numbered lines. At this time, it is desirable that the positive image signals and the negative image signals be outputted simultaneously.

For this purpose, the source driver 103 according to the present invention outputs the image signals from the image-signal output terminals 109a and 109b (XOUT1 and XOUT2) at the first timing during a horizontal period, and outputs the image signals from the image-signal output terminals 109c and 109d (XOUT3 and XOUT4) at the second timing which is different from the first timing. Otherwise, the source driver 103 outputs the image signals from the image-signal output terminals 109a and 109d (XOUT1 and XOUT4) at the first timing during a horizontal period, and outputs the image signals from the image-signal output terminals 109b and 109c (XOUT2 and XOUT3) at the second timing which is different from the first timing in the same horizontal period as the first timing is included.

The positive D/A converters 107p select positive gray scale voltages. In addition, the negative D/A converters 107n select negative gray scale voltages. The output buffers 120 switch the positive gray scale voltages to the negative gray scale voltages and vise versa, and output the switched gray scale voltages.

Here, detailed descriptions will be provided for the output buffers 120 according to this embodiment with reference to FIG. 10. FIG. 10 is a diagram showing a configuration of one of the output buffer units 120. The output buffer unit 120 includes straight switches 116, cross switches 117, output buffers 110, output switches 111, neutral switches 118 and a common node 119.

As shown in FIG. 9, the input of the display data holding unit 105 is connected to the controller 104, and the output side of the display data holding unit 105 is connected to the latch circuit A 106a and the latch circuit B 106b. The output side of each of the latch circuits 106 is connected to the D/A converters 107. The source drivers 103 are connected with the source lines of the liquid crystal display panel 101 through a plurality of image-signal output terminals 109. Image signals outputted from the output buffer units 120 are supplied respectively to the source lines SL of the liquid crystal display panel 101 through the image-signal output terminals 109.

The straight switches 116 are turned on when positive gray scale voltages inputted from the positive D/A converter 107p are supplied to the odd-numbered image-signal output terminals 109a and 109c (XOUT1 and XOUT3). In addition, the straight switches 116 are turned on when negative gray scale voltages inputted from the negative D/A converter 107n are supplied to the even-numbered image-signal output terminals 109b and 109d (XOUT2 and XOUT4). The cross switches 117 are turned on when negative gray scale voltages inputted from the negative D/A converter 107n are supplied to the odd-numbered image-signal output terminals 109a and 109c (XOUT1 and XOUT3). In addition, the cross switches 117 are turned on when positive gray scale voltages inputted from the positive D/A converter 107n are supplied to the even-numbered image-signal output terminals 109b and 109d (XOUT2 and XOUT4). In other words, the straight switches 116 and the cross switches 117 reverse the polarities of the image signals supplied to the odd-numbered image-signal output terminals 109a and 109c (XOUT1 and XOUT3) and the even-numbered image-signal output terminals 109b and 109d (XOUT2 and XOUT4), and switch the polarities. In this respect, the straight switches 116 and the cross switches 117 are termed as polarity switching circuits.

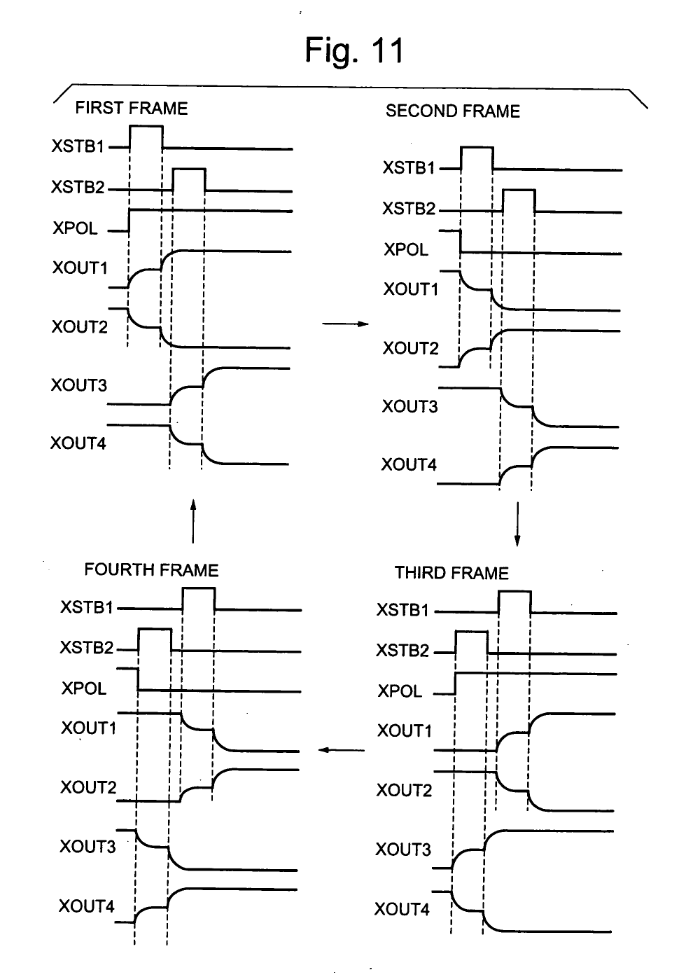

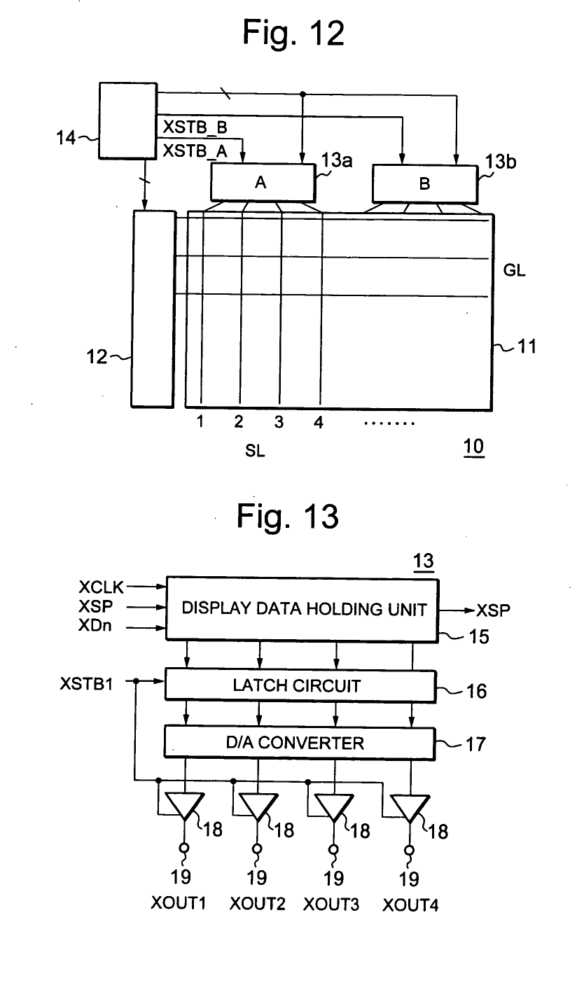

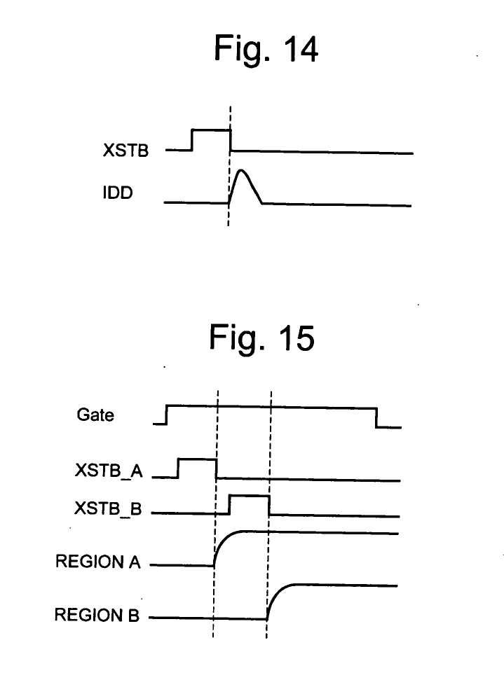

Here, detailed descriptions will be provided for an operation which is performed by the source driver 103 having the aforementioned configuration with reference to FIG. 11. In the first frame, an image-output control signal 1 (XSTB1) starts to operate earlier than an image-output control signal 2 (XSTB2) when a polarity signal XPOL is at an “H” level. For this reason, with regard to the sequence of timings in the first frame, a third timing representing the rise of the image-output control signal 1 (XSTB1) is followed by a first timing representing the fall of the image-output control signal 1 (XSTB1), followed by a fourth timing representing the rise of the image-output control signal 2 (XSTB2), followed by a second timing representing the fall of the image-output control signal 2 (XSTB2).

The polarity signal XPOL is inputted from the controller 104 to the polarity switching circuits. When the polarity signal XPOL is turned to the “H” level, the straight switches 116 are turned on, and the cross switches 117 are turned off.

The first image-output control signal (XSTB1) is inputted from the controller 104 to the first output buffer unit 120a. At the rise edge of the first image-output control signal (XSTB1) (which is the third timing), the output switches 111 are turned off, and the neutral switches 118 are turned on. This neutralizes the negative voltages at the odd-numbered image-signal output terminals 109a and 109c as well as the positive voltages at the odd-numbered image-signal output terminals 109b and 109d. In other words, all of the odd-numbered data lines DL and the even-numbered data lines DL of the liquid crystal display panel 101 are short-circuited through the common node 119, and thereby the voltages of the data lines are averaged.

In addition, the image-output control signal 1 (XSTB1) is also inputted to the first latch circuit A 106a. The first latch circuit A 106a latches the display data outputted parallel from the display data holding unit 105 at the rise edge of the image-output control signal 1 (XSTB1) representing the third timing. At this point, the first latch circuit A 106a latches the positive display data to be outputted to the first data line DL and the negative display data to be outputted to the second data line DL.

Subsequently, the latch circuit A 106a outputs, to the positive D/A converter 107p, the latched positive display data to be outputted to the first data line, and outputs, to the negative D/A converter 107n, the latched negative display data to be outputted to the second data line. The D/A converters 107p and 107n apply D/A conversion to a plurality of gray scale voltages generated by a gray scale voltage generating circuit (not illustrated), and output desired gray scale voltages to the first output buffer unit 120a, in accordance with the display data which have been inputted to the D/A converters 107p and 107n.

Then, the first output buffer unit 120a converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 1 (XSTB1), which fall edge represents the first timing, and thus the image signals obtained by the conversion are outputted to the image-signal output terminals 109a and 109b (XOUT1 and XOUT2) simultaneously. Specifically, positive image signals corresponding to the positive display data are outputted from the image-signal output terminal 109a (XOUT1), and negative image signals corresponding to the negative display data are outputted from the image-signal output terminal 109b (XOUT2).

The second latch circuit B 106b starts to latch, and to output, the display data later than the first latch circuit A 106a. An image-output control signal 2 (XSTB2) which is the second image-output control signal is inputted from the controller 104 to the second latch circuit B 106b. The second latch circuit B 106b latches the display data outputted parallel from the display data holding unit 105 at the rise edge of the image-output control signal 2 (XSTB2) representing the fourth timing. At this point, the second latch circuit B 106b latches the positive display data to be outputted to the third data line DL and the negative display data to be outputted to the fourth data line DL.

Furthermore, the second latch circuit B 106b outputs, to the positive D/A converter 107p, the latched positive display data to be outputted to the third data line, and outputs, to the negative D/A converter 107n, the latched negative display data to be outputted to the fourth data line. The D/A converters 107p and 107n apply D/A conversion to a plurality of gray scale voltages generated by the gray scale voltage generating circuit (not illustrated), and output desired gray scale voltages to the second output buffer unit 120b, in accordance with the display data which have been inputted to the D/A converters 107p and 107n.

Then, the second output buffer unit 120b converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 2 (XSTB2) representing the second timing, and thus the image signals obtained by the conversion are outputted to the image-signal output terminals 109c and 109d (XOUT3 and XOUT4) simultaneously. Specifically, positive image signals corresponding to the positive display data are outputted from the image-signal output terminal 109c (XOUT3), and negative image signals corresponding to the negative display data are outputted from the image-signal output terminal 109d (XOUT4).

In the second frame coming after the first frame, when the polarity signal XPOL is turned to an “L” level, the image-output control signal 1 (XSTB1) operates prior to the image-output control signal 2 (XSTB2). For this reason, with regard to the sequence of timings in the second frame, the third timing representing the rise of the image-output control signal 1 (XSTB1) is followed by the first timing representing the fall of the image-output control signal 1 (XSTB1), followed by the fourth timing representing the rise of the image-output control signal 2 (XSTB2), followed by the second timing representing the fall of the image-output control signal 2 (XSTB2).

The polarity signal XPOL is inputted from the controller 104 to the polarity switching circuits. When the polarity signal XPOL is turned to the “L” level, the straight switches 116 are turned off, and the cross switches 117 are turned on.

The first image-output control signal (XSTB1) is inputted from the controller 104 to the first output buffer unit 120a. At the rise edge of the first image-output control signal (XSTB1) (which is the third timing), the output switches 111 are turned off, and the neutral switches 118 are turned on. This neutralizes the positive voltages at the odd-numbered image-signal output terminals 109a and 109c as well as the negative voltages at the even-numbered image-signal output terminals 109b and 109d. In other words, the odd-numbered data lines DL and the even-numbered data lines DL of the liquid crystal display panel 101 are short-circuited through the common node 119, and thereby the voltages of the data lines are averaged.

In addition, the image-output control signal 1 (XSTB1) is also inputted to the first latch circuit A 106a. The first latch circuit A 106a latches the display data outputted parallel from the display data holding unit 105 at the rise edge of the image-output control signal 1 (XSTB1) representing the third timing. At this point, the first latch circuit A 106a latches the negative display data to be outputted to the first data line DL and the positive display data to be outputted to the second data line DL.

Subsequently, the latch circuit A 106a outputs, to the negative D/A converter 107n, the latched negative display data to be outputted to the first data line, and outputs, to the positive D/A converter 107p, the latched positive display data to be outputted to the second data line. The D/A converters 107p and 107n apply D/A conversion to a plurality of gray scale voltages generated by the gray scale voltage generating circuit (not illustrated), and output desired gray scale voltages to the first output buffer unit 120a, in accordance with the display data which have been inputted to the D/A converters 107p and 107n.

Then, the first output buffer unit 120a converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 1 (XSTB1), which fall edge represents the first timing, and thus the image signals obtained by the conversion are outputted to the image-signal output terminals 109a and 109b (XOUT1 and XOUT2). Specifically, negative image signals corresponding to the negative display data are outputted from the image-signal output terminal 109a (XOUT1), and positive image signals corresponding to the positive display data are outputted from the image-signal output terminal 109b (XOUT2).

The second latch circuit B 106b starts to latch, and to output, the display data later than the first latch circuit A 106a. The image-output control signal 2 (XSTB2) which is the second image-output control signal has been inputted from the controller 104 to the second latch circuit B 106b. The second latch circuit B 106b latches the display data outputted parallel from the display data holding unit 105 at the rise edge of the image-output control signal 2 (XSTB2) representing the fourth timing. At this point, the second latch circuit B 106b latches the negative display data to be outputted to the third data line DL and the positive display data to be outputted to the fourth data line DL.

Furthermore, the second latch circuit B 106b outputs, to the negative D/A converter 107n, the latched negative display data to be outputted to the third data line, and outputs, to the positive D/A converter 107p, the latched positive display data to be outputted to the fourth data line. The D/A converters 107p and 107n apply D/A conversion to a plurality of gray scale voltages generated by the gray scale voltage generating circuit (not illustrated), and output desired gray scale voltages to the second output buffer unit 120b, in accordance with the display data which have been inputted to the D/A converters 107p and 107n.

Then, the second output buffer unit 120b converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 2 (XSTB2) representing the second timing, and thus the image signals obtained by the conversion are outputted to the image-signal output terminals 109c and 109d (XOUT3 and XOUT4) simultaneously. Specifically, negative image signals corresponding to the negative display data are outputted from the image-signal output terminal 109c (XOUT3), and positive image signals corresponding to the positive display data are outputted from the image-signal output terminal 109d (XOUT4).

In the third frame coming after the second frame, when the polarity signal XPOL is turned to an “H” level, the image-output control signal 2 (XSTB2) operates prior to the image-output control signal 1 (XSTB1). For this reason, with regard to the sequence of timings in the third frame, the fourth timing representing the rise of the image-output control signal 2 (XSTB2) is followed by the second timing representing the fall of the image-output control signal 2 (XSTB2), followed by the third timing representing the rise of the image-output control signal 1 (XSTB1), followed by the first timing representing the fall of the image-output control signal 1 (XSTB1).

The polarity signal XPOL is inputted from the controller 104 to the polarity switching circuits. When the polarity signal XPOL is turned to an “L” level, the straight switches 116 are turned on, and the cross switches 117 are turned off.

The second image-output control signal (XSTB2) is inputted from the controller 104 to the second output buffer unit 120b. At the rise edge of the second image-output control signal (XSTB2) (which is the fourth timing), the output switches 111 are turned off, and the neutral switches 118 are turned on. This neutralizes the negative voltages at the odd-numbered image-signal output terminals 109a and 109c as well as the positive voltages at the odd-numbered image-signal output terminals 109b and 109d. In other words, all of the odd-numbered data lines DL and the even-numbered data lines DL of the liquid crystal display panel 101 are short-circuited through the common node 119, and thereby the voltages of the data lines are averaged.

In addition, the image-output control signal 2 (XSTB2) is also inputted to the second latch circuit B 106b. The second latch circuit B 106b latches the display data outputted parallel from the display data holding unit 105 at the rise edge of the image-output control signal 2 (XSTB2) representing the fourth timing. At this point, the second latch circuit B 106b latches the positive display data to be outputted to the third data line DL and the negative display data to be outputted to the fourth data line DL.

Subsequently, the latch circuit B 106b outputs, to the positive D/A converter 107p, the latched positive display data to be outputted to the third data line, and outputs, to the negative D/A converter 107n, the latched negative display data to be outputted to the fourth data line. The D/A converters 107p and 107n apply D/A conversion to a plurality gray scale voltages generated by the gray scale voltage generating circuit (not illustrated), and output desired gray scale voltages to the first output buffer unit 120a, in accordance with the display data which have been inputted to the D/A converters 107p and 107n.

Then, the second output buffer unit 120b converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 2 (XSTB2), which fall edge represents the second timing, and thus the image signals obtained by the conversion are outputted to the image-signal output terminals 109c and 109d (XOUT3 and XOUT4) simultaneously. Specifically, a positive image signal corresponding to the positive display data is outputted from the image-signal output terminal 109c (XOUT3), and a negative image signal corresponding to the negative display data is outputted from the image-signal output terminal 109d (XOUT4).

The first latch circuit A 106a starts to latch, and to output, the display data later than the second latch circuit B 106b. The image-output control signal 1 (XSTB1) which is the first image-output control signal has been inputted from the controller 104 to the first latch circuit A 106a. The first latch circuit A 106a latches the display data outputted parallel from the display data holding unit 105 at the rise edge of the image-output control signal 2 (XSTB2) representing the third timing. At this point, the first latch circuit A 106a latches the positive display data to be outputted to the first data line DL and the negative display data to be outputted to the second data line DL.

Furthermore, the first latch circuit A 106a outputs, to the positive D/A converter 107p, the latched positive display data to be outputted to the first data line, and outputs, to the negative D/A converter 107n, the latched negative display data to be outputted to the second data line. The D/A converters 107p and 107n apply D/A conversion to a plurality of gray scale voltages generated by the gray scale voltage generating circuit (not illustrated), and output desired gray scale voltages to the first output buffer unit 120a, in accordance with the display data which have been inputted to the D/A converters 107p and 107n.

Then, the first output buffer unit 120a converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 1 (XSTB1) representing the first timing, and thus the image signals obtained by the conversion are outputted to the image-signal output terminals 109a and 109b (XOUT1 and XOUT2) simultaneously. Specifically, positive image signals corresponding to the positive display data are outputted from the image-signal output terminal 109a (XOUT1), and negative images signals corresponding to the negative display data are outputted from the image-signal output terminal 109b (XOUT2).

In the fourth frame coming after the third frame, when the polarity signal XPOL is turned to an “L” level, the image-output control signal 2 (XSTB2) operates prior to the image-output control signal 1 (XSTB1). For this reason, with regard to the sequence of timings in the fourth frame, the fourth timing representing the rise of the image-output control signal 2 (XSTB2) is followed by the second timing representing the fall of the image-output control signal 2 (XSTB2), followed by the third timing representing the rise of the image-output control signal 1 (XSTB1), followed by the first timing representing the fall of the image-output control signal 1 (XSTB1).

A polarity signal XPOL is inputted from the controller 104 to the polarity switching circuits. When the polarity signal XPOL is turned to the “L” level, the straight switches 116 are turned off, and the cross switches 117 are turned on.

The second image-output control signal (XSTB2) is inputted from the controller 104 to the second output buffer unit 120b. At the rise edge of the second image-output control signal (XSTB2) (which is the fourth timing), the output switches 111 are turned off, and the neutral switches 118 are turned on. This neutralizes the positive voltages at the odd-numbered image-signal output terminals 109a and 109c as well as the negative voltages at the odd-numbered image-signal output terminals 109b and 109d. In other words, the odd-numbered data lines DL and the even-numbered data lines DL of the liquid crystal display panel 101 are short-circuited through the common node 119, and thereby the voltages of the data lines are averaged.

In addition, the image-output control signal 2 (XSTB2) is also inputted to the second latch circuit B 106b. The second latch circuit B 106b latches the display data outputted parallel from the display data holding unit 105 at the rise edge of the image-output control signal 2 (XSTB2) representing the fourth timing. At this point, the second latch circuit B 106b latches the negative display data to be outputted to the third data line DL and the positive display data to be outputted to the fourth data line DL.

Subsequently, the latch circuit B 106b outputs, to the negative D/A converter 107n, the latched negative display data to be outputted to the third data line, and outputs, to the positive D/A converter 107p, the latched positive display data to be outputted to the fourth data line. The D/A converters 107p and 107n apply D/A conversion to a plurality gray scale voltages generated by the gray scale voltage generating circuit (not illustrated), and output desired gray scale voltages to the second output buffer unit 120b, in accordance with the display data which have been inputted to the D/A converters 107p and 107n.

Then, the second output buffer unit 120b converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 2 (XSTB2), which fall edge represents the second timing, and thus the image signals obtained by the conversion are outputted to the image-signal output terminals 109c and 109d (XOUT3 and XOUT4). Specifically, negative image signals corresponding to the negative display data are outputted from the image-signal output terminal 109c (XOUT3), and positive image signals corresponding to the positive display data are outputted from the image-signal output terminal 109d (XOUT4).

The first latch circuit A 106a starts to latch, and to output, the display data later than the second latch circuit B 106b. The image-output control signal 1 (XSTB1) which is the first image-output control signal has been inputted from the controller 104 to the first latch circuit A 106a. The first latch circuit A 106a latches the display data outputted parallel from the display data holding unit 105 at the rise edge of the image-output control signal 1 (XSTB1) representing the third timing. At this point, the first latch circuit A 106a latches the negative display data to be outputted to the first data line DL and the positive display data to be outputted to the second data line DL.

Furthermore, the first latch circuit A 106a outputs, to the negative D/A converter 107n, the latched negative display data to be outputted to the first data line, and outputs, to the positive D/A converter 107p, the latched positive display data to be outputted to the second data line. The D/A converters 107p and 107n apply D/A conversion to a plurality of gray scale voltages generated by the gray scale voltage generating circuit (not illustrated), and output desired gray scale voltages to the first output buffer unit 120a, in accordance with the display data which have been inputted to the D/A converters 107p and 107n.

Then, the first output buffer unit 120a converts the gray scale voltages, which have been inputted from the D/A converter 107p or the D/A converter 107n, to image signals by means of applying impedance conversion to the gray scale voltages, and outputs the image signals. Thereafter, the switches 111 are turned on at the fall edge of the image-output control signal 1 (XSTB1) representing the first timing, and thus the image signals obtained by the conversion are outputted to the image-signal output terminals 109a and 109b (XOUT1 and XOUT2) simultaneously. Specifically, negative image signals corresponding to the negative display data are outputted from the image-signal output terminal 109a (XOUT1), and positive image signals corresponding to the positive display data are outputted from the image-signal output terminal 109b (XOUT2).

In this manner, the image signals are outputted respectively to the data lines of the liquid crystal display panel 101 with any one of the first timing and the second timing which are different from each other. In other words, the number of the image signals outputted simultaneously from each of the source drivers according to the present embodiment is reduced to one half of the number of image signals outputted simultaneously from a source driver according to the conventional technologies, as in the case of the first embodiment. This makes it possible to inhibit the peak current which would otherwise occur instantaneously in each of the source driver chips. Consequently, this makes it possible to inhibit electromagnetic interference (EMI) noise which would otherwise stem from the peak current.

Furthermore, in the case of the source driver 103 according to this embodiment, the positive image signals and the negative image signals are outputted simultaneously. During each cycle of four frames, the timing, with which the image signals are outputted to the first and second data lines, and the timing, with which the image signals are outputted to the third and fourth data lines, are staggered for each two frames by means of alternating the two output control signals (XSTB1 and XSTB2) back and forth. This makes it possible to enhance the image quality.

In the case of the fourth embodiment, output of the display data and the image signals from each of the source drivers 103 is controlled by use of the two signals, that is, the image-output control signal 1 (XSTB1) and the image-output control signal 2 (XSTB2). However, the present invention is not limited to this. Three or more image-output control signals (XSTBs) may be used as in the case of the first embodiment. Adjacent image-signal output terminals may be designed to output the image signals respectively with three timings which are different from one another, for example, by means of setting up the three different timings in a way that the three different timings correspond to the colors R, G and B.

In this case, it is desirable that any one of the three colors be outputted with the same timing. In the case of the dot inversion driving system using the colors R, G and B, the polarities of the image signals are reversed for each of the sub-pixels respectively representing the colors R, G and B. For this reason, the polarity of any one of the R, G and B sub-pixels constituting one pixel is different from the polarity of a sub-pixel with the same color in the neighboring pixels.

In other words, image signals with different polarities are supplied respectively to the two R sub-pixels included in two neighboring pixels from an image-signal output terminal XOUT(6m−5) or an image-signal output terminal XOUT(6m−2), where m is a natural number. In addition, image signals with different polarities are supplied respectively to the two G sub-pixels included in the two neighboring pixels from an image-signal output terminal XOUT(6m−4) or an image-signal output terminal XOUT(6m−1). Furthermore, image signals with different polarities are supplied respectively to the two B sub-pixels included in the two neighboring pixels from an image-signal output terminal XOUT(6m−3) or an image-signal output terminal XOUT(6m).

For this purpose, three image-output control signals, i.e., an image-output control signal 1 (XSTB1), an image-output control signal 2 (XSTB2) and an image-output control signal 3 (XSTB3), are provided, and thus image signals to be supplied to sub-pixels of the same color included in neighboring pixels are outputted simultaneously. In other words, it is desirable that the image-signal output terminal XOUT(6m−5) and the image-signal output terminal XOUT(6m−2) be controlled by use of the image-output control signal 1 (XSTB1), and that the image-signal output terminal XOUT(6m−4) and the image-signal output terminal XOUT(6m−1) be controlled by use of the image-output control signal 2 (XSTB2), and that the image-signal output terminal XOUT(6m−3) and the image-signal output terminal XOUT(6m) be controlled by use of the image-output control signal 3 (XSTB3).

It should be noted that, although the drive circuit according to the present invention has been described giving the example of the liquid crystal display device, the drive circuit according to the present invention is not limited to the liquid crystal display device. The drive circuit according to the present invention can be used for various image display devices including PDPs and organic EL display devices.

What is claimed is:

1. A drive circuit chip, comprising:
a plurality of image-signal input terminals receiving image signals;
a plurality of image-signal output terminals outputting image signals in response to image-output control signals supplied from the outside during the same horizontal period, said image signals being outputted with a plurality of timings including a first timing and a second timing different from the first timing.

2. The drive circuit chip according to claim 1,
wherein the plurality of the image-signal output terminals include first image-signal output terminals each outputting the image signals in response to the first timing and second image-signal output terminals each outputting the image signals in response to the second timing, and
wherein the first image-signal output terminal is arranged between the second image-signal output terminals.

3. The drive circuit chip according to claim 2,
wherein the first image-signal output terminals are odd-numbered image-signal output terminals in the drive circuit chip, and
wherein the second image-signal output terminals are even-numbered image-signal output terminals in the drive circuit chip.

4. The drive circuit chip according to claim 2,
wherein the first image-signal output terminals are (4m−3)th and (4m−2)th image-signal output terminals in the drive circuit chip, where m is a natural number, and
wherein the second image-signal output terminals are (4m−1)th and 4mth image-signal output terminals in the drive circuit chip, where m is the natural number.

5. The drive circuit chip according to claim 2,
wherein the first image-signal output terminals are (4m−3)th and (4m)th image-signal output terminals in the drive circuit chip, where m is a natural number, and
wherein the second image-signal output terminals are (4m−2)th and (4m−1)th image-signal output terminals in the drive circuit chip, where m is the natural number.

6. The drive circuit chip according to claim 4,
wherein the (4m−3)th and (4m−1)th image-signal output terminals are supplied with image signals with a first polarity, and
wherein the (4m−2)th and 4mth image-signal output terminals are supplied with image signals with a second polarity which is different from the first polarity.

7. The drive circuit chip according to claim 1,
wherein the plurality of the image-signal output terminals include first image-signal output terminals each outputting the image signals in response to the first timing, second image-signal output terminals each outputting the image signals in response to the second timing, which is different from the first timing, and third image-signal output terminals each outputting the image signals in response to the third timing, which is different from the first and the second timings, and
wherein the first image-signal output terminals are (3m−2)th image-signal output terminals in the drive circuit chip, where m is a natural number,
the second image-signal output terminals are (3m−1)th image-signal output terminals in the drive circuit chip, where m is the natural number, and
the third image-signal output terminals are (3m)th image-signal output terminals in the drive circuit chip, where m is the natural number.

8. The drive circuit chip according to claim 7,
wherein the first image-signal output terminals are (6m−5)th and (6m−2)th image-signal output terminals in the drive circuit chip, where m is a natural number,
the second image-signal output terminals are (6m−4)th and (6m−1)th image-signal output terminals in the drive circuit chip, where m is the natural number, and
the third image-signal output terminals are (6m−3)th and (6m)th image-signal output terminals in the drive circuit chip, where m is the natural number, and
wherein the (6m−5)th, (6m−3)th and (6m−1)th image-signal output terminals are supplied with the image signals with a first polarity, and
wherein the (6m−4)th, (6m−2)th and (6m)th image-signal output terminals are supplied with the image signals with a second polarity which is different from the first polarity.

9. The drive circuit chip according to claim 1, wherein a sequence of the plurality of timings is controlled in order that the sequence of the plurality of timings is different from a predetermined horizontal period to another or from a predetermined frame period to another.

10. The drive circuit chip according to claim 1, further comprising:
an expansion-and-hold circuit expanding, and holding, digital display data which has been inputted thereto sequentially, and outputting the digital display data parallel;
a D/A conversion circuit for applying D/A conversion to the held display data; and
buffer circuits,
wherein the expansion-and-hold circuit includes a first latch circuit for latching first display data out of the display data with a third timing, and a second latch circuit for latching second display data out of the display data with a fourth timing, and
wherein gray scale voltages obtained by applying the D/A conversion to output from the first latch circuit and output from the second latch circuit are outputted, as the image signals, to the image-signal output terminals through the buffers with the first and second timings.

11. The drive circuit chip according to claim 1, further comprising:
an expansion-and-hold circuit expanding, and holding, analogue display data which has been inputted thereto sequentially, and outputting the analogue display data parallel; and
buffer circuits,
wherein the expansion-and-hold circuit is configured of a plurality of switches and a plurality of capacities, and includes a first sample hold circuit latching first display data out of the display data with a third timing, and a second sample hold circuit latching second display data out of the display data with a fourth timing, and
wherein a voltage held by the first sample hold circuit and a voltage held by the second sample hold circuit are outputted, as image signals, to the image-signal output terminals through the buffer circuits with the first and second timings.

12. The drive circuit chip according to of claim 10, wherein the first to fourth timings are those different from one another.

13. The drive circuit chip according to claim 10, wherein the third and fourth timings are the same timings.

14. A display device comprising:
a drive circuit chip according to any one of claim 1;
a controller for supplying image-output signals to the drive circuit chip; and
a display panel driven by the drive circuit chip.
